(19) United States
(12) Patent Application Publication
(10) Pub. No.: US 2025/0062931 A1
(43) Pub. Date: Feb. 20, 2025

(54) ELECTRONIC CONTROL DEVICE, CONTROL SYSTEM, CONTROL METHOD, AND NON-TRANSITORY COMPUTER READABLE MEDIUM

(71) Applicant: DENSO CORPORATION, Kariya-city (JP)

(72) Inventor: YASUHIRO KOTANI, Kariya-city (JP)

(21) Appl. No.: 18/735,629

(22) Filed: Jun. 6, 2024

(30) Foreign Application Priority Data
Aug. 14, 2023 (JP) 2023-131888

(51) Int. Cl. H04L 12/40

(52) U.S. Cl. CPC H04L 12/40039; H04L 2012/40215; H04L 2012/40273

(57) ABSTRACT

An electronic control device includes a transceiver and a controller. The controller is configured to operate in one of multiple modes including a first mode, a second mode, and a third mode. The controller transitions from the first mode to the second mode in response to a stoppage of communication between the transceiver and a communication device during the controller operating in the first mode, and transitions from the second mode to the third mode in response to a predetermined period having passed without the communication in the second mode. The controller is configured to transition from the second mode to the first mode in response to an occurrence of the communication during the controller operating in the second mode except when the communication is a reception of a wake-up request that requests the controller to transition to the first mode.

### CROSS REFERENCE TO RERATED APPLICATION

This application is based on Japanese Patent Application No. 2023-131888 filed on Aug. 14, 2023, the disclosure of which is incorporated herein by reference in its entirety.

### TECHNICAL FIELD

The present disclosure relates to an electronic control device.

### BACKGROUND

Vehicles are equipped with a large number of electronic control devices, known as ECUs (Electronic Control Units), to control in-vehicle equipment. Connection of these ECUs to communication buses forms a network system in which the ECUs serve as nodes. In such network system, an operation mode of the ECUs transitions between a normal mode and a power-saving mode.

### SUMMARY

An electronic control device includes at least one transceiver configured to perform a communication with a communication equipment and a controller configured to carry out operating in one mode of a plurality of modes including a first mode, a second mode, and a third mode. The controller is further configured to carry out (i) operating in the first mode to execute processing related to the communication with the communication equipment during the at least one transceiver performing the communication, (ii) transitioning from the first mode to the second mode in response to a stoppage of the communication during the controller operating in the first mode, (iii) transitioning from the second mode to the third mode in response to a predetermined period having passed without the communication in the second mode, (iv) stopping at least a part of the processing related to the communication in the third mode, and (v) transitioning from the second mode to the first mode in response to an occurrence of the communication during the controller operating in the second mode except when the communication is a reception of a wake-up request that requests the controller to transition to the first mode.

A control method is executed by a computer of an electronic control device that includes at least one transceiver configured to perform a communication with a communication equipment. The control method includes (i) operating in a first mode to execute processing related to the communication during the transceiver performing the communication, (ii) transitioning from the first mode to a second mode in response to a stoppage of the communication during the computer operating in the first mode, (iii) transitioning from the second mode to a third mode in response to a predetermined period having passed without the communication in the second mode, (iv) stopping at least a part of the processing related to the communication in the third mode, and (v) transitioning from the second mode to the first mode in response to an occurrence of the communication during the computer operating in the second mode except when the communication is a reception of a wake-up request that requests the computer to transition to the first mode.

A non-transitory computer readable medium stores a computer program configured to be executed by a computer of an electronic control device. The electronic control device includes a transceiver configured to perform a communication with a communication equipment. The computer program includes instructions configured to, when executed by the computer, cause the computer to carry out (i) operating in a first mode to execute processing related to the communication during the transceiver performing the communication, (ii) transitioning from the first mode to a second mode in response to a stoppage of the communication during the processor operating in the first mode, (iii) transitioning from the second mode to the third mode in response to a predetermined period having passed without the communication in the second mode (iv) stopping at least a part of the processing related to the communication in the third mode, (v) transitioning from the second mode to the first mode in response to an occurrence of the communication during the controller operating in the second mode except when the communication is a reception of a wake-up request that requests the controller to transition to the first mode.

### BRIEF DESCRIPTION OF THE DRAWINGS

FIG. 1 is a block diagram illustrating a configuration of a control system.

FIG. 2 is a state transition diagram illustrating operation modes of a controller.

FIG. 3 is a flowchart of processing for entering a network mode or a bus-sleep mode from a prepare bus-sleep mode.

FIG. 4 is a flowchart of processing for entering a network mode from a sleep mode.

FIG. 5 is a flowchart of processing for entering the sleep mode from the prepare bus-sleep mode through the bus-sleep mode.

FIG. 6 is a diagram illustrating transition of the operation modes of the controller and the state of a transceiver.

### DETAILED DESCRIPTION

To begin with, examples of relevant techniques will be described.

Vehicles are equipped with a large number of electronic control devices, known as ECUs (Electronic Control Units), to control in-vehicle equipment. Connection of these ECUs to communication buses forms a network system in which the ECUs serve as nodes. In such network system, when no packets have flowed in the network for a certain period of time, an operation mode of the ECUs transitions from a normal mode to a power-saving mode. In the normal mode, various functions are operational. In the power-saving mode, some functions operational in the normal mode are stopped, which reduces power consumption.

For example, there is a network system that enables low power consumption by forming a partial network and by selectively activating nodes that form the network or having the nodes become dormant as needed. The partial network is a power supply control method based on the communication control of the CAN (Registered Trademark, Controller Area Network) protocol standard defined in ISO 11898-6.

Each ECU includes a transceiver as a communication interface for communicating with other ECUs. The transceiver assumes that other ECUs on the network are in the power-saving mode when a link connected to the ECUs breaks down, which is in a link-down state. The transceiver may transmit a wake-up request that requests the ECUs in the link-down state to enter the normal mode.

The transceiver may unintentionally transmit the wake-up request to an ECU that is ready to enter the power-saving mode from the normal mode when the transceiver erroneously recognizes that the link is in the link-down state, for example, due to poor communication conditions in the network.

When the ECU transitioning to the power-saving mode receives the wake-up request before executing processing to partially stop operations in the normal mode, the execution of the processing may be unintentionally prevented.

According to an aspect of the present disclosure, the present disclosure relates to an electronic control device that has a mode, such as a power-saving mode, to partially stop running operations. It is an objective of the present disclosure to achieve transition to the mode such as the power-saving mode without interrupted by receiving a wake-up request.

According to an embodiment of the present disclosure, an electronic control device for a vehicle includes at least one transceiver and a controller. The transceiver is configured to perform a communication with a communication equipment. The controller is configured to carry out operating in one mode of multiple modes including a first mode, a second mode, and a third mode.

The controller is configured to carry out operating in the first mode to execute processing related to the communication with the communication equipment during the at least one transceiver performing the communication.

The controller is configured to carry out transitioning from the first mode to the second mode in response to a stoppage of the communication during the controller operating in the first mode.

The controller is configured to carry out transitioning from the second mode to the third mode in response to a predetermined period having passed without the communication in the second mode.

The controller is configured to carry out stopping at least a part of the processing related to the communication in the third mode.

The controller is configured to carry out transitioning from the second mode to the first mode in response to an occurrence of the communication during the controller operating in the second mode except when the communication is a reception of a wake-up request that requests the controller to transition to the first mode.

This configuration enables to avoid entering the first mode from the second mode in response to receiving the wake-up request during transitioning from the first mode to the third mode. Thus, this configuration can achieve transition to the third mode of the controller in the electronic control device without interrupted by receiving the wake-up request.

Hereinafter, exemplary embodiments of the present disclosure will be described with reference to the drawings.

### 1. First Embodiment

### 1-1. Configuration

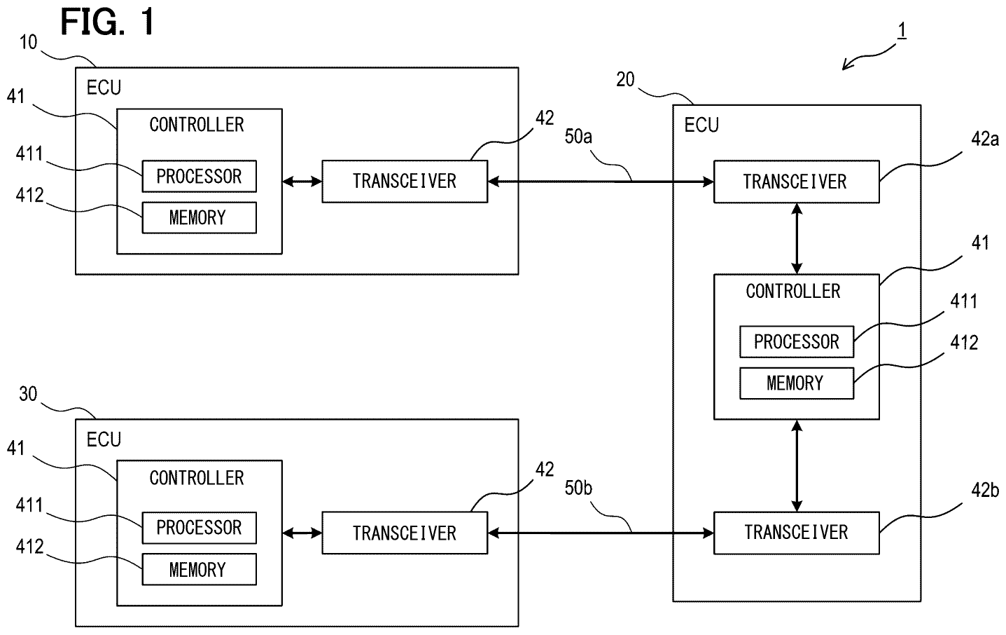

A control system 1 of this embodiment shown in FIG. 1 is installed in a vehicle. The control system 1 includes a first ECU 10, a second ECU 20, and a third ECU 30. The first ECU 10, the second ECU 20, and the third ECU 30 are connected to the same in-vehicle network. The first ECU 10 and the third ECU 30 may be an ECU that processes information obtained from sensors such as cameras and radars for autonomous driving, an ECU that processes information to be output to a display device such as a vehicle display or a meter, or an ECU that communicates with an external terminal. The second ECU 20 may be a relay device that transfers data received from another ECU that is connected to the second ECU 20. For example, the second ECU 20 may be a gateway or an Ethernet switch.

Each of the first ECU 10, the second ECU 20, and the third ECU 30 includes a controller 41 and at least one transceiver 42. In this embodiment, each of the first ECU 10 and the third ECU 30 has a single transceiver 42. The second ECU 20 includes transceivers 42a and 42b as the at least one transceiver 42.

The controller 41 is a microcontroller having a processor 411 and a memory 412. The processor 411 is configured to execute processing in accordance with a computer program recorded in the memory 412. The memory 412 may be RAM (i.e., Random Access Memory) and flash memory. The RAM is used as a working area during the processor 411 executing processing. The flash memory holds computer programs.

The transceiver 42 is a communication interface configured to communicate with other transceivers 42 through the in-vehicle network. The communication mentioned here includes transmissions and receptions of various signals, data, and the like. In this embodiment, the transceivers 42 perform one-to one communications.

The first ECU 10 and the second ECU 20 are connected to each other through a link 50a serving as a transmission path in the in-vehicle network. The first ECU 10 communicates with the second ECU 20 through the transceiver 42 of the first ECU 10 and the link 50a. The second ECU 20 communicates with the first ECU 10 through the transceiver 42a of the second ECU 20 and the link 50a. The first ECU 10 and the second ECU 20 may be configured to communicate with each other using an Ethernet protocol. The communication protocol is not limited to Ethernet, but may be CAN (i.e., Controller Area Network) or FlexRay. Ethernet is a registered trademark. CAN is a registered trademark. FlexRay is a registered trademark.

The second ECU 20 and the third ECU 30 are connected to each other through a link 50b serving as a transmission path in the in-vehicle network. The second ECU 20 communicates with the third ECU 30 through the transceiver 42b of the second ECU 20 and the link 50b. The third ECU 30 communicates with the second ECU 20 through the transceiver 42 of the third ECU 30 and the link 50b. The second ECU 20 and the third ECU 30 may be configured to communicate with each other using an Ethernet protocol. The communication protocol is not limited to Ethernet, but may be CAN or FlexRay.

The first ECU 10 and the third ECU 30 are not directly connected to each other in the in-vehicle network, but can communicate with each other through the second ECU 20.

### 1-2. Processing

### 1-2-1. Operating States and Functions of the Transceivers

The transceiver 42 operates in one state of multiple states. The multiple states include a normal state, a sleep state, and a sleep handshake state. The transceiver 42 transitions between the normal state, the sleep state, and the sleep handshake state according to a predetermined protocol. One example of the predetermined protocol is TC10 (i.e., Technical Committee 10) defined by the non-profit organization OPEN Alliance (i.e., One-Pair Ether-Net Alliance). The transceiver 42 further has a sleep function, a wake-up function, and a transfer function.

The normal state is a state in which the transceiver 42 has an ability to communicate with other transceivers 42. The sleep state is a state in which predetermined functions of the transceiver 42 that are available in the normal state are stopped. An example of the predetermined functions of the transceiver 42 is a function of transmitting various signals, data, and the like to other transceivers 42. The sleep state is a state in which power to restart the stopped predetermined functions is not supplied. Thus, the sleep state is a power-saving state in which power consumption is reduced compared to the normal state. The transceiver 42 enters the sleep state when an ignition switch of the vehicle is turned on.

The sleep handshake state is a state passed during the transition from the normal state to the sleep state. The transceiver 42 in the sleep handshake state performs a handshake to notify an adjacent ECU, which serves as an adjacent node in the in-vehicle network, of a transition to the sleep state. After completion of the handshake, the transceiver 42 stops the predetermined functions of the transceiver 42 and enters the sleep state. When the handshake has not completed within a predetermined period (for example, within 16 milliseconds), the transceiver 42 determines that the handshake has failed and enters the normal state.

The sleep function is executed when requested by the controller 41 of the ECU to which the transceiver 42 belongs (hereinafter, referred to as a local ECU). By executing the sleep function, processing for stopping the predetermined functions of the transceiver 42 is performed. In other words, the sleep function is executed for the transceiver 42 to enter the sleep state from the normal state through the sleep handshake state in response to the request from the controller 41.

The sleep function includes performing a handshake to notify the adjacent ECU of transition to the sleep state. That is, when the transceiver 42 executes the sleep function, the transceiver 42 transmits a signal (hereinafter, referred to as a sleep signal) that informs the execution of the sleep function to the adjacent ECU, receives a signal from the adjacent ECU in response to the sleep signal (hereinafter referred to as a sleep response), and stops the predetermined functions of the transceiver 42 in response to the sleep response.

The sleep function is also executed when the transceiver 42 receives the sleep signal from the adjacent ECU. In this case, the transceiver 42 notifies the controller 41 of the local ECU of having received the sleep signal, transmits the sleep response to the adjacent ECU, and then stops the own predetermined functions.

When the transceiver 42 transmits or receives the sleep signal, the transceiver 42 enters the sleep handshake state from the normal state. Then, the transceiver 42 receives or transmits the sleep response, and performs processing to stop the predetermined functions of the transceiver 42. After the processing has been completed, the transceiver 42 enters the sleep state from the sleep handshake state.

The wake-up function is a function to perform processing to restart the predetermined functions of the transceiver 42 that have stopped by the sleep function. In other words, the wake-up function is a function for the transceiver 42 to enter the normal state from the sleep state.

The wake-up function is executed when the transceiver 42 receives a wake-up request. The wake-up request is a signal that requests the controller 41 to enter the network mode A101, which will be described later.

The wake-up request received by the transceiver 42 may be a wake-up request transmitted from the adjacent ECU or a wake-up request transmitted from the controller 41 of the local ECU to the adjacent ECU. When the transceiver 42 receives the wake-up request from the adjacent ECU, the transceiver 42 notifies the controller 41 of the reception of the wake-up request. When the transceiver 42 receives the wake-up request transmitted from the controller 41 of the local ECU to the adjacent ECU, the transceiver 42 transmits the wake-up request to the adjacent ECU.

After completing the processing to restart the predetermined functions of the transceiver 42 that has stopped by the sleep function, the transceiver 42 enters the normal state from the sleep state. When the transceiver 42 receives a wake-up request from the adjacent ECU, the transfer function is a function to transfer the wake-up request to another transceiver 42 of the local ECU. A transceiver 42 to which the wake-up request is transferred can be selected arbitrarily. In this embodiment, for example, when the transceiver 42a of the second ECU 20 receives the wake-up request from the first ECU 10, the transceiver 42a transfers the wake-up request to the transceiver 42b by the transfer function. The transceiver 42b transmits the transferred wake-up request to the transceiver 42 of the third ECU 30.

### 1-2-2. Operation Modes of the Controller

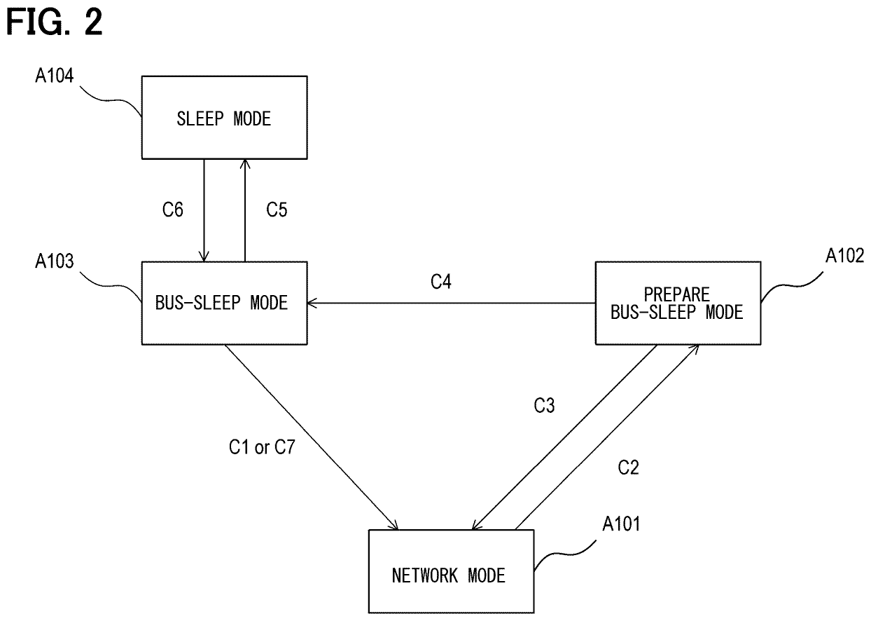

As shown in FIG. 2, the controller 41 has a network mode A101, a prepare bus-sleep mode A102, a bus-sleep mode A103, and a sleep mode A104 as operation modes. The controller 41 transitions between the network mode A101, the prepared bus-sleep mode A102, the bus-sleep mode A103, and the sleep mode A104 in accordance with a predetermined protocol. One example of the predetermined protocol is UDP Network Management (i.e., UDPNm), defined by AUTOSAR (i.e., AUTomotive Open System ARchitecture), which is a global development partnership in the automotive industry.

The network mode A101 is an operation mode in which the controller 41 communicates with the adjacent ECU through the transceiver 42. The controller 41 in the network mode A101 executes processing related to a communication with the adjacent ECU. Examples of the processing related to the communication include processing of creating various signals, data, and the like to be transmitted to the adjacent ECUs and transmit them to the transceiver 42, and processing of obtaining various signals, data, and the like received by the transceiver 42 from the adjacent ECU. The network mode A101 is maintained until a predetermined period has elapsed since the communication with the adjacent ECU stopped. The predetermined period is, for example, several milliseconds to several thousand milliseconds.

The prepared bus-sleep mode A102 is an operation mode in which the ECU waits for a predetermined period to elapse while no communication occurs between the local ECU and the adjacent ECU. The predetermined period is, for example, about several milliseconds to several thousand milliseconds. The predetermined period in the prepare bus-sleep mode A102 may be different from the predetermined period in the network mode A101. The network mode A101 and the prepare bus-sleep mode A102 are included in normal mode in which various functions of the ECU are operatable.

The bus-sleep mode A103 is an operation mode that performs processing required to stop some of the functions operating in the network mode A101 when entered from the prepare bus-sleep mode A102. Examples of the functions to be stopped is creating various signals, data, and the like to be transmitted to the adjacent ECU and transmitting them to the transceiver 42. Examples of processing required to stop some of the functions include processing of disabling the setting values of the controller 41 relating to transmission to the transceiver 42, and processing of stopping operating clocks, timers, and the like used in the functions to be stopped.

In addition, the bus-sleep mode A103 is an operation mode that performs the processing required to start operation in the network mode A101 when entered from the sleep mode A104 or when the power is supplied to the controller 41. Examples of the processing required to start operation include processing of enabling the setting values of the controller 41 related to transmission to the transceiver 42, and processing of starting the operating clocks and timers used in creating various signals and data to be transmitted to the adjacent ECU and transmitting them to the transceiver 42. The processing performed by the controller 41 in the bus-sleep mode A103 includes processing of restarting functions that have stopped after transition from the prepare bus-sleep mode A102 to the bus-sleep mode A103. Furthermore, the controller 41 transmits a wake-up request to the adjacent ECU. As a result, the controller 41 of the adjacent ECU enters the network mode A101 in which communication is available.

The sleep mode A104 is an operation mode in which some of the functions that operate in the network mode A101 are stopped. Alternatively, power is not supplied to the controller 41 in the sleep mode A104. The functions stopped in the sleep mode A104 are the functions for which the processing required to stop them has been performed in the bus-sleep mode A103. The sleep mode A104 is a power-saving mode in which some functions are stopped to reduce power consumption compared to the normal mode.

### 1-2-3. Transition of the Controller Operation Modes

The transition of the controller operation modes is explained with reference to FIG. 2. When the ignition switch of the vehicle is turned on, the controller 41 enters the bus-sleep mode A103 as an initial mode. Alternatively, the initial mode may be the sleep mode A104, and the controller 41 may enter the bus-sleep mode A103 when the ignition switch of the vehicle is turned on. In the bus-sleep mode A103, the controller 41 executes processing required to start operation in the network mode A101. Examples of such processing include processing of enabling the setting values of the controller 41 relating to transmission to the transceiver 42, and processing of starting operation clocks and timers used in creating various signals and data to be transmitted to the adjacent ECU and in transmitting them to the transceiver 42. The controller 41 determines that a transition condition C1 is satisfied when this processing has been completed, and enters the network mode A101. The transition condition C1 is that the processing required to start operation in the network mode A101 has been completed.

When the controller 41 determines that a transition condition C2 is satisfied in the network mode A101, the controller 41 enters the prepare bus-sleep mode A102. The transition condition C2 is that a predetermined period (for example, several milliseconds to several thousand milliseconds) has elapsed without a communication with the adjacent ECU. In addition, the transition condition C2 may include that the ECU receives information or an instruction indicating a transition to the prepare bus-sleep mode A102 from the adjacent ECU.

When the controller 41 determines that a transition condition C3 is satisfied in the prepare bus-sleep mode A102, the controller 41 enters the network mode A101. The transition condition C3 is that a communication with the adjacent ECU occurs. However, when a wake-up request is received in the prepare bus-sleep mode A102 as the communication, the controller 41 does not enter the network mode A101. That is, the transition condition C3 is that a communication with the adjacent ECU other than a reception of a wake-up request has occurred.

When the controller 41 determines that a transition condition C4 is satisfied in the prepare bus-sleep mode A102, the controller 41 enters the bus-sleep mode A103. The transition condition C4 is a condition that a predetermined period (for example, several milliseconds to several thousand milliseconds) has elapsed without an occurrence of communication with the adjacent ECU other than a reception of a wake-up request. The predetermined period in the transition condition C4 may be different from the predetermined period in the transition condition C2, or may not be provided. In other words, the predetermined period in the transition condition C4 may be 0 seconds. Furthermore, counting the predetermined period in the transition condition C4 may be start at the time when the controller 41 enters the prepare bus-sleep mode A102 or at the last communication in the network mode A101. When counting the predetermined period in the transition condition C4 starts at the last communication in the network mode A101, the predetermined period in the transition condition C4 becomes equal to or greater than the predetermined period in the transition condition C2.

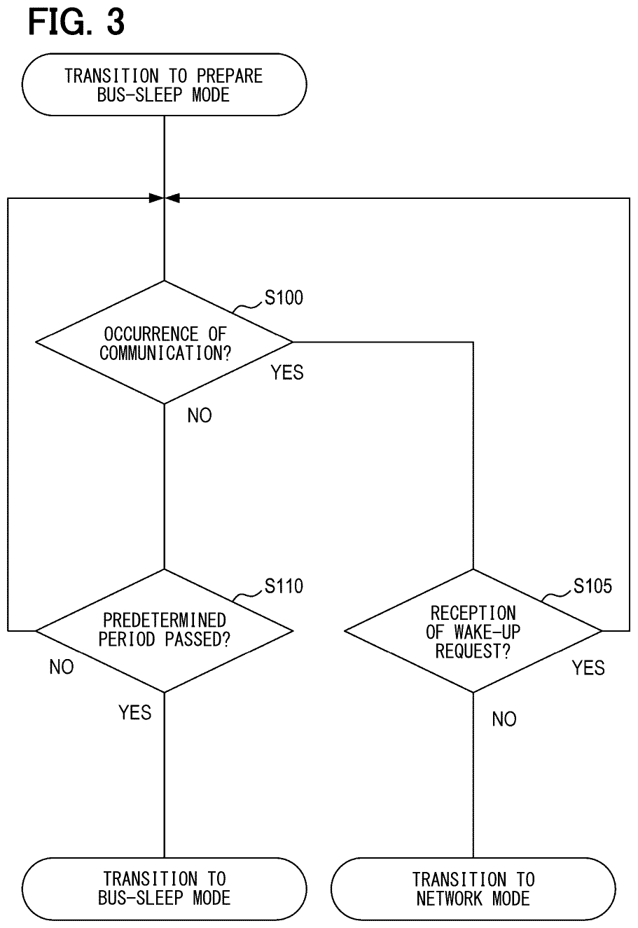

The transition conditions C3 and C4 and the processing of the controller 41 in the prepare bus-sleep mode A102 will be described with reference to the flowchart in FIG. 3. The controller 41 in the prepare bus-sleep mode A102 waits until the predetermined period has elapsed without communication with the adjacent ECU (S100: NO, S110: NO).

When the controller 41 determines that the predetermined period has elapsed in S110 (S110: YES), the controller 41 determines that the transition condition C4 is satisfied and enters the bus-sleep mode A103. On the other hand, when the controller 41 determines in S100 that communication has occurred (S100: YES), the processing proceeds to S105 and the controller 41 determines whether the occurred communication in S100 is a reception of a wake-up request.

When the controller 41 determines in S105 that the occurred communication in S100 is a reception of a wake-up request (S105: YES), the controller 41 returns to the processing of S100. At this time, the time count for determining whether the predetermined period has elapsed is maintained without being reset.

On the other hand, when the controller 41 determines in S105 that the occurred communication in S100 is not a reception of a wake-up request (S105: NO), the controller 41 determines that the transition condition C3 is satisfied and enters the network mode A101.

Accordingly, the controller 41 transitions from the prepare bus-sleep mode A102 to the network mode A101 or to the bus-sleep mode A103. When the controller 41 determines that a transition condition C5 is satisfied in the bus-sleep mode A103, the controller 41 enters the sleep mode A104. The transition condition C5 is that the processing required to stop some of the functions operating in the network mode A101 (for example, processing of disabling the setting values of the controller 41 related to transmission to the transceiver 42, and processing of stopping the operating clocks, timers, and the like used in the functions to be stopped) has been completed. The transition condition C5 includes a condition that a predetermined function of the transceiver 42 (for example, a transmitting function of various signals, data, and the like to another transceiver 42) has stopped by the sleep function.

When the controller 41 determines that a transition condition C6 is satisfied in the sleep mode A104, the controller 41 enters the bus-sleep mode A103. The transition condition C6 is a condition that a factor to trigger return from the power-saving mode to the normal mode (hereinafter, referred to as a return factor) occurs. The return factor also includes receiving a wake-up request from the adjacent ECU. The return factor may be different for each ECU. Examples of the return factor includes that the vehicle door is unlocked and that the TCU (i.e., Telematics Control Unit) installed in the vehicle receives a specified signal from outside the vehicle (for example, an operating signal for vehicle equipment such as the engine and the air conditioner).

When the controller 41 determines that a transition condition C7 is satisfied in the bus-sleep mode A103, the controller 41 enters the network mode A101. Transition condition C7 is that the processing required to enter network mode A101 in response to the return factor has been completed. Such processing is for example processing of enabling the setting values of the controller 41 related to transmission to the transceiver 42 and processing of starting the operating clocks and timers used in creating various signals and data to be transmitted to the adjacent ECU and in transmitting them to the transceiver 42. The transition condition C7 includes that the predetermined function of the transceiver 42 (for example, a function of transmitting various signals and data to another transceiver 42) is restarted by the wake-up function.

### 1-2-4. Enabling and Disabling the Functions of the Transceiver According to Transition of the Controller Operation Modes

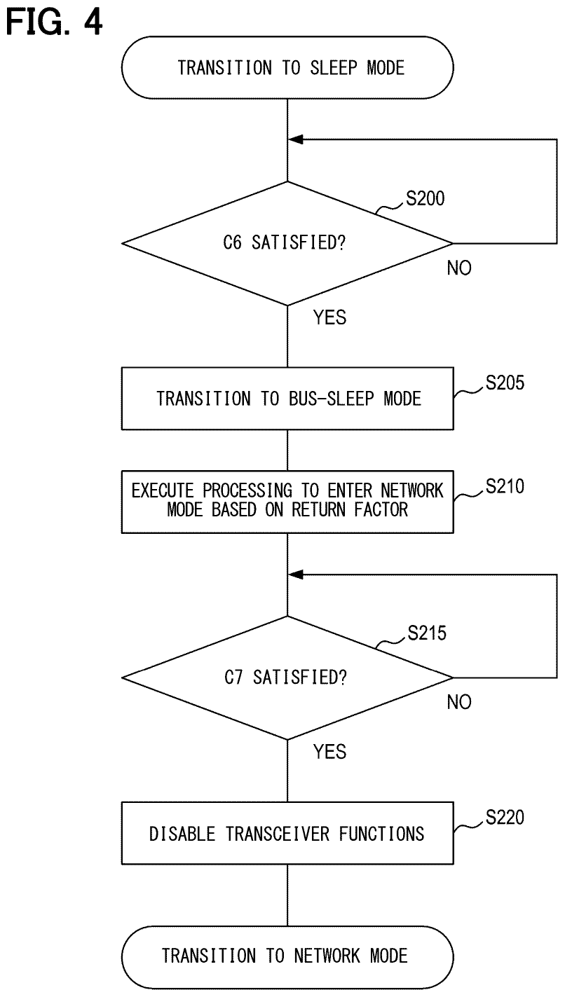

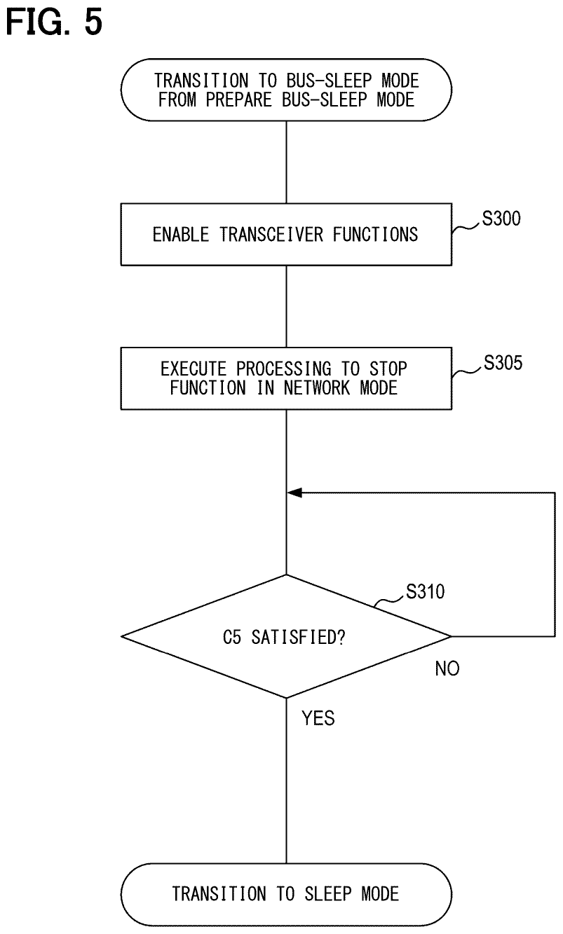

The processing of enabling or disabling the sleep function, the wake-up function, and the transfer function of the transceiver 42 in response to transition of the controller operation modes will be explained regarding the flowcharts in FIGS. 4 and 5.

When the controller 41 enters the sleep mode A104, processing shown in FIG. 4 starts. First, the controller 41 repeats the processing of S200 (S200: NO) until determining that the transition condition C6 is satisfied, for example, until determining the return factor occurs.

When the controller 41 determines in S200 that the transition condition C6 is satisfied (S200: YES), the processing proceeds to S205 and the controller 41 enters the bus-sleep mode A103. Next, the controller 41 executes processing required to enter the network mode A101 in response to the return factor in S210. The processing includes executing the wake-up function of the transceiver 42.

Next, the controller 41 determines in S215 whether the transition condition C7 is satisfied. For example, the controller 41 determines whether the processing required to enter the network mode A101 in response to the return factor has been completed. The controller 41 repeats the processing of S215 until determining that the transition condition C7 is satisfied (S215: NO).

When the controller 41 determines in S215 that the transition condition C7 is satisfied (S215: YES), the processing proceeds to S220 and the controller 41 disables the sleep function, the wake-up function, and the transfer function of the transceiver 42. Then, the controller 41 enters the network mode A101 and ends the processing shown in FIG. 4.

Accordingly, when returning to the network mode A101 (i.e., the normal mode) from the sleep mode A104 (i.e., the power-saving mode), the controller 41 disables the sleep function, the wake-up function, and the transfer function of the transceiver 42 before entering the network mode A101.

When the ignition switch is turned on, the controller 41 enters the bus-sleep mode A103 and similarly performs the above-mentioned processing of S210 and succeeding processing. However, in this case, the transition condition C7 in S215 is to be read as the transition condition C1, that is the condition the processing required to start the operation in the network mode A101 has been completed.

When the controller 41 enters the bus-sleep mode A103 from the prepare bus-sleep mode A102, the controller 41 starts the processing shown in FIG. 5. First, the controller 41 enables the sleep function, the wake-up function, and the transfer function of the transceiver 42 in S300.

Next, in S305, the controller 41 executes processing required to stop some of the functions operating in the network mode A101. The processing includes executing the sleep function of the transceiver 42.

Next, in S310, the controller 41 repeats the processing of S310 (S310: NO) until determining that the transition condition C5 is satisfied. The transition condition C5 is, for example, that the predetermined functions of the transceiver 42 are stopped by the sleep function.

When the controller 41 determines in S310 that the transition condition C5 is satisfied (S310: YES), the controller 41 transitions to the sleep mode A104 and ends the processing shown in FIG. 5. Accordingly, when the controller 41 is in the course of transition from the prepare bus-sleep mode A102 (i.e., the normal mode) to the sleep mode A104 (i.e., the power-saving mode) through the bus-sleep mode A103, the controller 41 enters the bus-sleep mode A103 from the prepare bus-sleep mode A102 and then enables the sleep function, the wake-up function, and the transfer function of the transceiver 42.

As described above, the controller 41 selectively enables and disables the sleep function, the wake-up function, and the transfer function of the transceiver 42 not to execute these functions in the prepare bus-sleep mode A102.

### 1-2-5. Transition Between the Normal Mode and the Power-Saving Mode of the ECU in the Entire Control System

1-2-5-1. Transition from the Power-Saving Mode to the Normal Mode

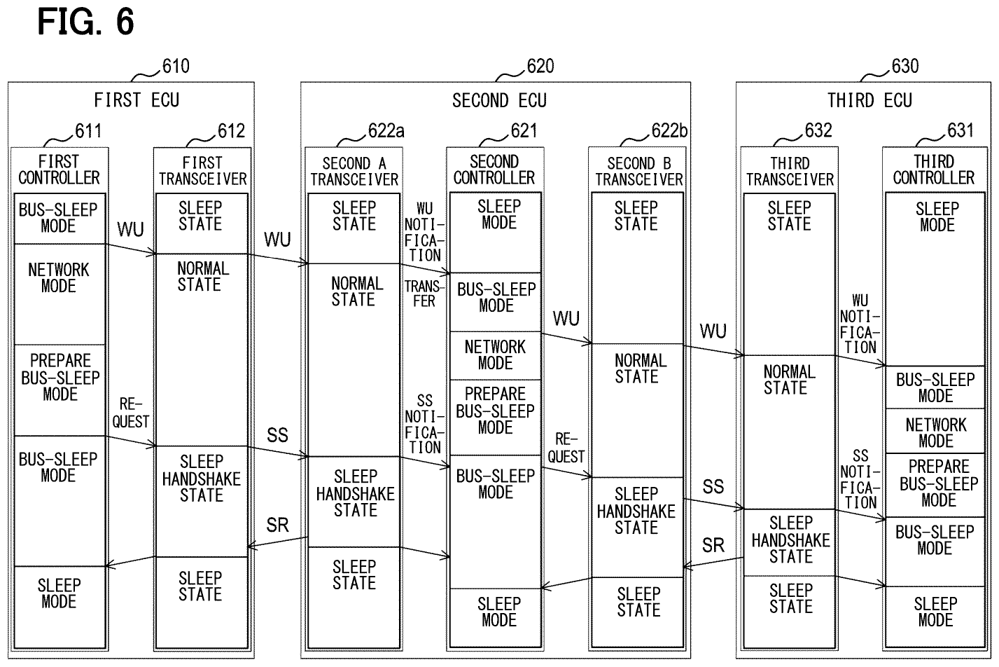

In the control system 1, the transition of the operation modes of the controllers 41 and operation states of the transceivers 42 of the ECUs will be described with reference to FIG. 6. The transition will be described in two cases, the case the control system 1 is returned from the power-saving mode and enters the normal mode and the case the control system 1 enters the power-saving mode from the normal mode.

A first ECU 610, a second ECU 620, and a third ECU 630 described below correspond to the first ECU 10, the second ECU 20, and the third ECU 30, respectively. A first controller 611, a second controller 621, and a third controller 631 correspond to the controllers 41 provided in the first ECU 10, the second ECU 20, and the third ECU 30, respectively. A first transceiver 612 and a third transceiver 632 correspond to the transceivers 42 provided in the first ECU 10 and the third ECU 30, respectively. A second A transceiver 622a and a second B transceiver 622b correspond to the transceiver 42a and the transceiver 42b provided in the second ECU 20, respectively.

The first ECU 610, the second ECU 620, and the third ECU 630 in the control system 1 are all in the power saving mode as an example. In this state, the controllers 611, 621, and 631 of each ECU are in the sleep mode A104, and the transceivers 612, 622a, 622b, and 632 are in the sleep state.

When the return factor occurs, a predetermined ECU corresponding to the return factor among the first ECU 610, the second ECU 620, and the third ECU 630 enters the bus-sleep mode A103. Then, the predetermined ECU corresponding to the return factor starts the processing required to start operation in the network mode A101. In addition, when the ignition switch is turned on, the predetermined ECU also enters the bus-sleep mode A103. In the following, the first ECU 610 exemplifies the predetermined ECU corresponding to the return factor, and an example that the first ECU transitions from the sleep mode A104 to the bus-sleep mode A103 will be described. The same applies to the case where the ignition switch is turned on and the first ECU 610 enters the bus-sleep mode A103.

When the first ECU 610 completes the processing required to start operation in the network mode A101, the first controller 611 of the first ECU 610 determines that the transition condition C1 is satisfied, and enters the network mode A101. In addition, the first controller 611 transmits a wake-up request to the first transceiver 612. The wake-up request is directed to the second ECU 620 as the adjacent ECU. The notation “WU” in FIG. 6 means transmitting a wake-up request. The arrows associated with the notation “WU” indicate the source and destination of a wake-up request.

When the first transceiver 612 receives the wake-up request from the first controller 611, the first transceiver 612 executes processing to restart its own predetermined functions that have been stopped by the sleep function, and transitions from the sleep state to the normal state. Then, the first transceiver 612 transmits the wake-up request to the second ECU 620.

When the second A transceiver 622a of the second ECU 620 receives the wake-up request, the second A transceiver 622a executes processing to restart its own predetermined functions that have been stopped by the sleep function, and transitions from the sleep state to the normal state. In addition, the second A transceiver 622a notifies the second controller 621 of having received the wake-up request. The description “WU notification” in FIG. 6 means a notification of having received a wake-up request. In addition, the second A transceiver 622a transfers the wake-up request to the second B transceiver 622b through the second controller 621 by the transfer function.

Upon receiving the above notification, the second controller 621 transitions from the sleep mode A104 to the bus-sleep mode A103, and executes the processing required to start operation in the network mode A101. When the processing has been completed, the second controller 621 transitions from the bus-sleep mode A103 to the network mode A101. In addition, the second controller 621 transmits the wake-up request, which is transferred by the transfer function of the second A transceiver 622a, to the second B transceiver 622b.

When the second B transceiver 622b receives the wake-up request, the second B transceiver 622b executes processing to restart its own predetermined functions that have been stopped by the sleep function, and transitions from the sleep state to the normal state. Then, the second B transceiver 622b transmits a wake-up request to the third ECU 630.

When the third transceiver 632 of the third ECU 630 receives the wake-up request, the third transceiver 632 executes processing to restart its own predetermined functions that have been stopped by the sleep function, and transitions from the sleep state to the normal state. In addition, the third transceiver 632 notifies the third controller 631 of having received the wake-up request.

Upon receiving the above notification, the third controller 631 transitions from the sleep mode A104 to the bus-sleep mode A103, and executes the processing required to start operation in the network mode A101. When the processing has been completed, the third controller 631 transitions from the bus-sleep mode A103 to the network mode A101.

In this manner, the wake-up request transmitted from the first ECU 610 is sent to the second ECU 620 and the third ECU 630. As a result, the controllers 611, 621, 631 of the ECUs transition to the network mode A101, the transceivers 612, 622a, 622b, 632 of the ECUs transition to the normal state, and the ECUs transition to the normal mode.

1-2-5-2. Transition from the Normal Mode to the Power-Saving Mode

When the predetermined period has elapsed while no communication has occurred between the ECU in the normal mode and the adjacent ECU, the controllers 611, 621, 621 of the ECUs determine that the transition condition C2 is satisfied and enter the prepare bus-sleep mode A102.

When the predetermined period has elapsed in the prepare bus-sleep mode A102 without communication with the adjacent ECU, the controllers 611, 621, 631 of the ECUs determine that the transition condition C4 is satisfied and enter the bus-sleep mode A103. In the following, an example in which the transition condition C4 is satisfied at in the order of the first ECU 610, the second ECU 620, and the third ECU 630 will be described.

The first controller 611 of the first ECU 610 that has entered the bus-sleep mode A103 requests the first transceiver 612 to execute the sleep function. The notation “REQUEST” in FIG. 6 means a request to execute the sleep function. When the first transceiver 612 is requested by the first controller 611 to execute the sleep function, the first transceiver 612 transitions to the sleep handshake state and transmits a sleep signal to the second ECU 620 as the adjacent ECU. The notation “SS” in FIG. 6 means a sleep signal. The arrows associated with the notation “SS” indicate the source and destination of the sleep signal.

The second A transceiver 622a of the second ECU 620 that has received the sleep signal from the first ECU 610 transitions to the sleep handshake state and returns a sleep response to the first transceiver 612.

When the first transceiver 612 receives the sleep response from the second ECU 620, the first transceiver 612 stops its own predetermined functions and transitions to the sleep state. The notation “SR” in FIG. 6 means a sleep response. The arrows associated with the notation “SR” indicate the source and destination of the sleep response.

When the first controller 611 determines that the predetermined functions of the first transceiver 612 are stopped by the sleep function and the transition condition C5 is satisfied, the first controller 611 transitions to the sleep mode A104.

When the second A transceiver 622a of the second ECU 620 receives the sleep signal from the first ECU 610, the second A transceiver 622a notifies the second controller 621 of having received the sleep signal. The notation “SS notification” in FIG. 6 means a notification of having received a sleep signal. Then, the second A transceiver 622a stops its predetermined functions and transitions to the sleep state.

When the second controller 621 receives the above notification while staying in the bus-sleep mode A103, the second controller 621 requests the second B transceiver 622b to execute the sleep function. When the second B transceiver 622b is requested by the second controller 621 to execute the sleep function, the second B transceiver 622b transitions to the sleep handshake state and transmits a sleep signal to the third ECU 630 as the adjacent ECU.

The third transceiver 632 of the third ECU 630 that has received the sleep signal from the second ECU 620 transitions to the sleep handshake state and returns a sleep response to the second B transceiver 622b.

When the second B transceiver 622b receives the sleep response from the third ECU 630, the second B transceiver 622b stops its own predetermined functions and transitions to the sleep state. When the second controller 621 determines that the predetermined functions of both the second A transceiver 622a and the second B transceiver 622b are stopped by the sleep function and the transition condition C5 is satisfied, the second controller 621 transitions to the sleep mode A104.

When the third transceiver 632 of the third ECU 630 receives the sleep signal from the second ECU 620, the third transceiver 632 notifies the third controller 631 of having received the sleep signal. Then, the third transceiver 632 stops its predetermined functions and transitions to the sleep state.

When the third controller 631 confirms that the predetermined function of the third transceiver 632 is stopped by the sleep function while staying in the bus-sleep mode A103 and the transition condition C5 is satisfied, the third controller 732 transitions to the sleep mode A104.

According to the first embodiment described above, the following effects can be obtained.

(1a) As shown in S105 of FIG. 3, when the controller 41 receives a wake-up request in the prepare bus-sleep mode A102, the controller 41 does not enterthe network mode A101. Thus, when the ECU is transitioning from the prepare bus-sleep mode A102 to the bus-sleep mode A103, and a wake-up request is erroneously transmitted to the ECU from the adjacent ECU which is connected to the ECU through a link, the transition of the controller 41 from the prepare bus-sleep mode A102 to the network mode A101 is avoided. That is, it is possible to avoid unintentional interruption of the transition of the controller 41 to the bus-sleep mode A103.

(1b) As shown in S220 of FIG. 4, when the controller 41 transitions to the network mode A101, the controller 41 disables the sleep function, the wake-up function, and the transfer function of the transceiver 42. The sleep function, the wake-up function, and the transfer function of the transceiver 42 remain disabled during the controller 41 operating in the prepare bus-sleep mode A102. Thus, when the adjacent ECU unintentionally transmits a wake-up request or a sleep signal to the ECU that is transitioning from the prepare bus-sleep mode A102 to the bus-sleep mode A103, the transceiver 42 of the ECU does not execute the sleep function and the wake-up function. That is, the transceiver 42 of the ECU does not notify the controller 41 in the ECU of having received a wake-up request or a sleep signal. Thus, the controller 41 of the ECU can avoid transitioning from the prepare bus-sleep mode A102 to the network mode A101. That is, it is possible to avoid unintentional interruption of the transition of the controller 41 to the bus-sleep mode A103.

In addition, when the controller 41 operates in the prepare bus-sleep mode A102, the transfer function of the transceiver 42 is disabled, so that each ECU does not transmit a wake-up request received from a first adjacent ECU to a second adjacent ECU. Thus, when the controller 41 of the second adjacent ECU is transitioning from the prepare bus-sleep mode A102 to the bus-sleep mode A103, the controller 41 of the second adjacent ECU can avoid transitioning to the network mode A101 from the prepare bus-sleep mode A102. That is, it is possible to avoid unintentional interruption of the transition of the controller 41 in the second adjacent ECU to the bus-sleep mode A103.

(1c) When the controller 41 enters the bus-sleep mode A103 from the prepare bus-sleep mode A102, the controller 41 enables the sleep function, the wake-up function, and the transfer function of the transceiver 42. Thus, when the controller 41 is in the bus-sleep mode A103, the transceiver 42 can execute the sleep function, the wake-up function, and the transfer function.

In the above embodiments, the network mode A101 corresponds to an example of the first mode, the prepare bus-sleep mode A102 corresponds to an example of the second mode, and the bus-sleep mode A103 corresponds to an example of the third mode.

### 2. Other Embodiments

Although the embodiments of the present disclosure have been described above, the present disclosure is not limited to the embodiments described above, and various modifications can be made to implement the present disclosure.

(2a) In the above embodiment, the control system 1 includes three ECUs: the first ECU 10, the second ECU 20, and the third ECU 30. However, the number of the ECUs is not limited to three and may be two, four or more.

(2b) In the above embodiments, each ECU in the control system 1 includes a controller 41 and one or two transceivers 42, but it is sufficient for the ECU to have at least one transceiver 42. The ECU may include three or more transceivers 42.

Furthermore, the ECUs in the control system 1 may include an ECU that operates as a switch and that does not have a controller 41 but has multiple transceivers 42.

(2c) In the above embodiments, when returning from the sleep mode A104 (i.e., a power-saving mode) to the network mode A101 (i.e., a normal mode), the controller 41 disables the sleep function, the wake-up function, and the transfer function of the transceiver 42 before entering the network mode A101. However, the timing for disabling the sleep function, the wake-up function, and the transfer function of the transceiver 42 does not limited to the timing just before the controller 41 enters the network mode A101. The timing for disabling the sleep function, the wake-up function, and the transfer function can be arbitrary set as long as it is before entering the prepare bus-sleep mode A102 through the network mode A101. For example, the controller 41 may disable the sleep function, the wake-up function, and the transfer function after the transition condition C2 is satisfied in the network mode A101 and before the controller 41 enters the prepare bus-sleep mode A102.

(2d) Multiple functions of one configuration element in the above embodiments may be implemented by multiple configuration elements, or a single function of one configuration element may be implemented by multiple configuration elements. A part of the configurations described in the above embodiments may be omitted. At least a part of the configurations in one embodiment may be added to or substituted for the configurations of another embodiment.

(2e) The present disclosure can be realized in various forms in addition to the ECU and the control system described above. For example, the present disclosure can be realized in the form of a control system that includes the ECU as a component, a computer program for causing a computer to function as the ECU, a non-transitory physical storage medium such as a semiconductor memory on which the computer program is stored, a control method, and the like.

1. An electronic control device for a vehicle, the electronic control device comprising:
at least one transceiver configured to perform a communication with a communication equipment; and
a controller configured to carry out:
operating in one mode of a plurality of modes including a first mode, a second mode, and a third mode, wherein
the controller is further configured to carry out:
operating in the first mode to execute processing related to the communication with the communication equipment during the at least one transceiver performing the communication;
transitioning from the first mode to the second mode in response to a stoppage of the communication during the controller operating in the first mode;
transitioning from the second mode to the third mode in response to a predetermined period having passed without the communication in the second mode;
stopping at least a part of the processing related to the communication in the third mode; and
transitioning from the second mode to the first mode in response to an occurrence of the communication during the controller operating in the second mode except when the communication is a reception of a wake-up request that requests the controller to transition to the first mode.

2. The electronic control device according to claim 1, wherein
the at least one transceiver has:
a sleep function that is executed in response to a request from the controller, the sleep function being a function to stop a predetermined function of the transceiver; and
a wake-up function that is executed in response to receiving the wake-up request, the wake-up function being a function to start the predetermined function having stopped by the sleep function, and
the controller is further configured to carry out selectively enabling and disabling the sleep function and the wake-up function to avoid execution of the sleep function and the wake-up function in the second mode.

3. The electronic control device according to claim 2, wherein
the controller is configured to carry out enabling the sleep function and the wake-up function in the third mode.

4. The electronic control device according to claim 1, wherein
the at least one transceiver includes a first transceiver and a second transceiver,
the first transceiver has a transfer function to transfer the wake-up request to the second transceiver in response to receiving the wake-up request from the communication equipment, and
the controller is configured to carry out selectively enabling and disabling the transfer function to avoid execution of the transfer function in the second mode.

5. The electronic control device according to claim 4, wherein
the controller is configured to carry out enabling the transfer function in the third mode.

6. A control system comprising
the electronic control device according to claim 1, wherein
the electronic control device is one of electronic control devices,
the electronic control devices serve as nodes forming an in-vehicle network, and
each of the electronic control devices is configured to communicate with an adjacent one of the electronic control devices as the communication equipment.

7. A control method executed by a computer of an electronic control device, the electronic control device including at least one transceiver configured to perform a communication with a communication equipment, the control method comprising:
operating in a first mode to execute processing related to the communication during the transceiver performing the communication;
transitioning from the first mode to a second mode in response to a stoppage of the communication during the computer operating in the first mode;
transitioning from the second mode to a third mode in response to a predetermined period having passed without the communication in the second mode;
stopping at least a part of the processing related to the communication in the third mode; and
transitioning from the second mode to the first mode in response to an occurrence of the communication during the computer operating in the second mode except when the communication is a reception of a wake-up request that requests the computer to transition to the first mode.

8. A non-transitory computer readable medium storing a computer program configured to be executed by a computer of an electronic control device, the electronic control device including a transceiver configured to perform a communication with a communication equipment, the computer program comprising instructions configured to, when executed by the computer, cause the computer to carry out:
operating in a first mode to execute processing related to the communication during the transceiver performing the communication;
transitioning from the first mode to a second mode in response to a stoppage of the communication during the processor operating in the first mode;
transitioning from the second mode to a third mode in response to a predetermined period having passed without the communication in the second mode;
stopping at least a part of the processing related to the communication in the third mode;
transitioning from the second mode to the first mode in response to an occurrence of the communication during the controller operating in the second mode except when the communication is a reception of a wake-up request that requests the computer to transition to the first mode.

9. An electronic control device for a vehicle comprising:
at least one transceiver configured to perform a communication with a communication equipment;
at least one processor; and
at least one memory storing instructions that, when executed by the at least one processor, cause the at least one processor to carry out at least:
transitioning to a network mode from a sleep mode in response to receiving a wake-up request;
operating in the network mode to execute processing related to the communication;
transitioning from the network mode to a prepare bus-sleep mode in response to a stoppage of the communication in the network mode;
transitioning from the prepare bus-sleep mode to a bus-sleep mode upon determining that a predetermined period has passed without the communication in the prepare bus-sleep mode;
stopping, in the prepare bus-sleep mode, a part of the processing executed in the network mode; and
transitioning from the prepare bus-sleep mode to the network mode in response to an occurrence of the communication in the prepare bus-sleep mode except when the communication is a reception of the wake-up request.

10. The electronic control device according to claim 1, wherein
a sleep function that is executed in response to a request from the controller, the sleep function being a function to stop a predetermined function of the transceiver; and
a wake-up function that is executed in response to receiving the wake-up request, the wake-up function being a function to start the predetermined function having stopped by the sleep function, and
the controller is configured to carry out disabling the wake-up function before entering the second mode.

11. The electronic control device according to claim 1, wherein
the at least one transceiver includes a first transceiver and a second transceiver,
the first transceiver has a transfer function to transfer the wake-up request to the second transceiver in response to receiving the wake-up request from the communication equipment, and
the controller is configured to carry out disabling the transfer function before entering the second mode.
